(19) United States
(12) Patent Application Publication
(10) Pub. No.: US 2025/0247920 A1
(43) Pub. Date: Jul. 31, 2025

(54) WINDOW DEFROSTER FOR SMALL STRUCTURES

(71) Applicant: David Hale, Somerset, WI (US)

(72) Inventor: David Hale, Somerset, WI (US)

(21) Appl. No.: 18/424,541

(22) Filed: Jan. 26, 2024

(51) Int. Cl. H05B 3/84

(52) U.S. Cl. CPC H05B 3/84

(57) ABSTRACT

Usability of a heated hunting blind or similar small structure in cold weather conditions is improved by providing a low cost and easily repositionable window defroster powered by a portable power supply such as a battery, battery pack or generator.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

### I. Field of the Invention

The present invention relates to window defrosters. More specifically, the present invention relates to window defrosters specifically configured for defrosting the windows of hunting blinds and other small, heated enclosures used in cold climates.

### II. Discussion of the Prior Art

### Summary of the Invention

Hunting blinds and other small structures typically include windows for viewing the ambient environment. Such structures are often heated using propane ceramic heaters. The use of such heaters causes water vapor to form within the structure. This water vapor condenses on windows of the structure causing frost to form on the windows or the windows to fog. This frost or fog makes it difficult to see through the windows, for example obscuring a hunter's ability to see game passing by a hunting blind.

Hunting blind manufacturers offer a proposed solution to this problem, specifically wiping away the condensation. This, at best, is a temporary solution. Most typically, the windows quickly again fog or even frost over and the wiping action smears the windows decreasing visibility through the windows.

The present invention solves the problem described above by providing window defrost systems for use in hunting blinds and other small enclosures with windows susceptible to fogging and frosting over. As used herein, “defroster” is used with reference to any such system used for defrosting or defogging a window.

One embodiment of the invention comprises a metal bar of a predetermined width (e.g., ¼ inch) and a predetermined length (e.g., 12 inches). The bar is adapted to be temporarily attached to the window using a fastener comprising magnets. Use of the magnets allows the bar to be quickly and easily repositioned for optimal performance. Other fasteners providing these same advantages may also be used without deviating from the invention. The metal bar is connected to a portable electrical power source (e.g., a battery or a portable generator). Application of electricity to, and the resistance of the metal of the bar, causes the bar to heat and the heat from the bar to radiate thereby defogging and defrosting the window to which the bar is attached.

Another embodiment of the invention comprises an assembly including a heating element, such as a polyimide thermal heat strip of a predetermined width and length (e.g., 5 millimeters by 185 millimeters), attached to and centered along the length of a heat sink of a predetermined width and length (e.g., ¼ inch by 12 inches). The fasteners of this embodiment comprise a separate N52 magnet is press fit into each end of the heat sink. Two additional magnets on the opposite side of a window are used to attach this assembly to the window. Other types of magnets, and other types of fasteners, such as spring clips and binder clips, may be used without deviating from the invention. An electrical power source such as a battery or portable generator is coupled to the heat strip to cause the heat strip to generate heat. This heat is transferred to the heat sink and radiates from the assembly across the window to which the assembly is attached and serves to defog/defrost the window. Again, the use of magnets to hold the assembly in place allows the assembly to be easily repositioned to maximize performance.

### BRIEF DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts:

FIG. 1 is a front view of a first embodiment of a window defroster/defogger made in accordance with the present invention.

FIG. 2 is a front view of a second embodiment of a window defroster/defogger made in accordance with the present invention.

FIG. 3 is a top view of the of a window defroster/defogger of FIG. 1 attached to a window of a hunting blind or the like.

FIG. 4 is a top view of the of a window defroster/defogger of FIG. 2 attached to a window of a hunting blind or the like.

FIG. 5 is a schematic diagram showing additional features that may be used to control the operation of the heating element of FIGS. 2 and 4.

FIG. 6 illustrates the use of clips to temporarily fasten a heater to a window.

FIG. 7 illustrates the use of clips, in combination with a strap, to temporarily fasten a heater to a window.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

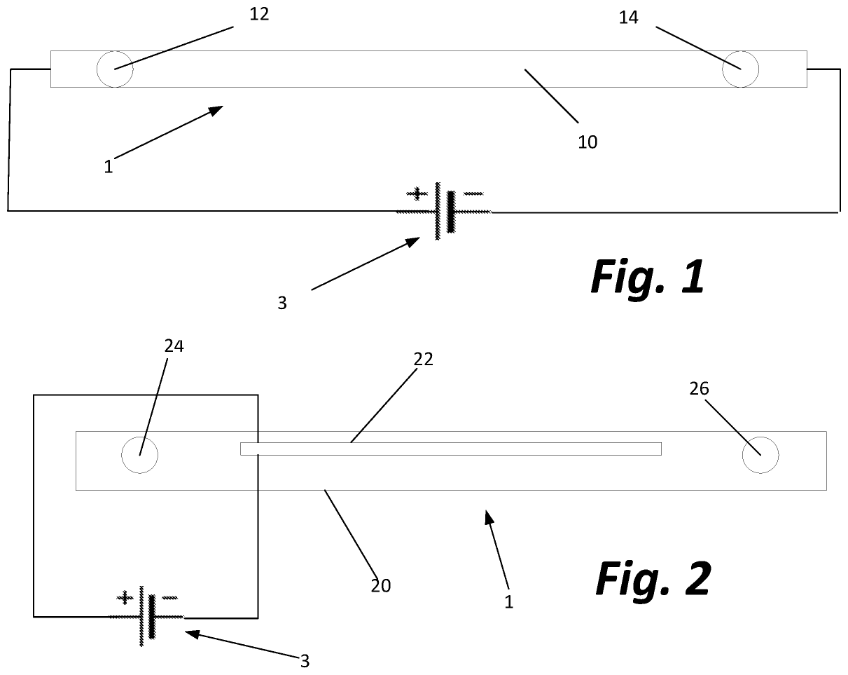

Two embodiments of a defroster 1 made in accordance with the present invention are shown in FIGS. 1 through 4 of the drawings. Each is configured to be positioned relative to window 2 and then attached to window 2 in a manner that permits easy repositioning of the defroster 1 relative to the boundaries of a surface of the window 2. Each is powered by a portable power source 3 such as a battery, a group of batteries or a portable generator.

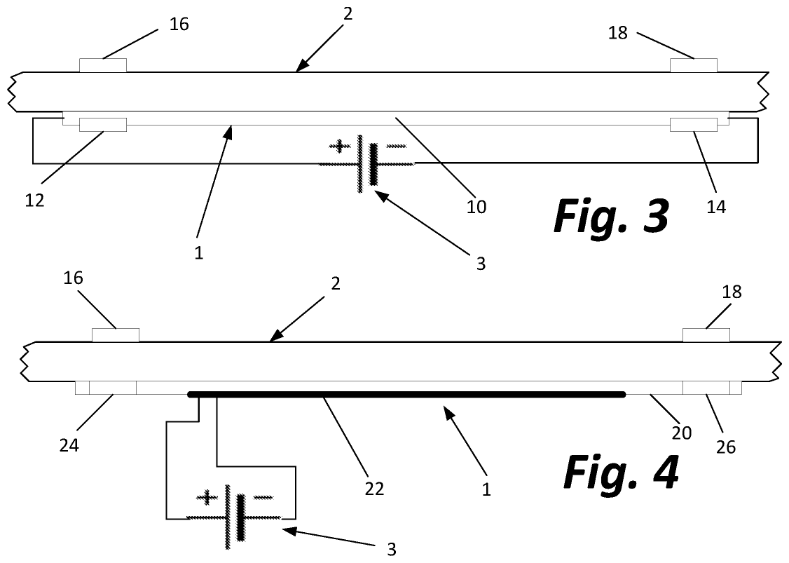

The embodiment shown in FIGS. 1 and 3 comprises heater consisting of a metal bar 10. Metal bar 10 is attached to the power source 3 and produces heat according to the following equation E I′RI Joules where “I” is the current through the resistance in amps, “R” is the resistance of the metal bar and “T” is the time in seconds. The metal bar may be made from aluminum, black anodized aluminum or an alloy that is highly resistive, has a high melting point, is resistant to oxidation, has a high tensile strength, and a low temperature coefficient of resistivity. More specifically, the highly resistive metal bar 10 is made from a material that has a high enough melting point and a low enough coefficient of resistivity to permit the metal bar 10 to be operated within the predetermined operating temperature range of the heater. Nickel-Chromium alloys, Iron-Chrome-Aluminum alloys, and Copper-Nickel alloys, carbon fiber and any other heating element, among other alloys, may be used.

While counter intuitive given that a higher temperature weakens a magnet's strength and magnetic field, magnets are used to attach metal bar 10 to window 2. Specifically, magnets 12 and 14 are coupled to metal bar 10 and the heater is placed in face-to face registration with one side of a window of an enclosure. Magnets 16 and 18 are position in face-to-face registration with a second side of the window adjacent to magnets 12 and 14 with opposite poles of each pair of magnets (i.e., 12 and 16, and 14 and 18) facing each other. The type of material from which a magnet is made determines how temperature affects the magnet. Ferrite magnets and magnets made of cobalt have a high resistance to demagnetization and are suitable for use. Neodymium magnets, for example, N52 Neodymium magnets may also be used so long as the temperature of the metal bar does not exceed about 175 degrees Fahrenheit. Of course, the metal bar should be held well below that temperature, e.g., in a range of 80 degrees Fahrenheit to about 110 degrees Fahrenheit, even when connected to the power source to prevent injury to someone touching the metal bar 10. This temperature range is also adequate to effectively defog and defrost windows. The magnets may be epoxy coated so that they are not adversely affected by humidity.

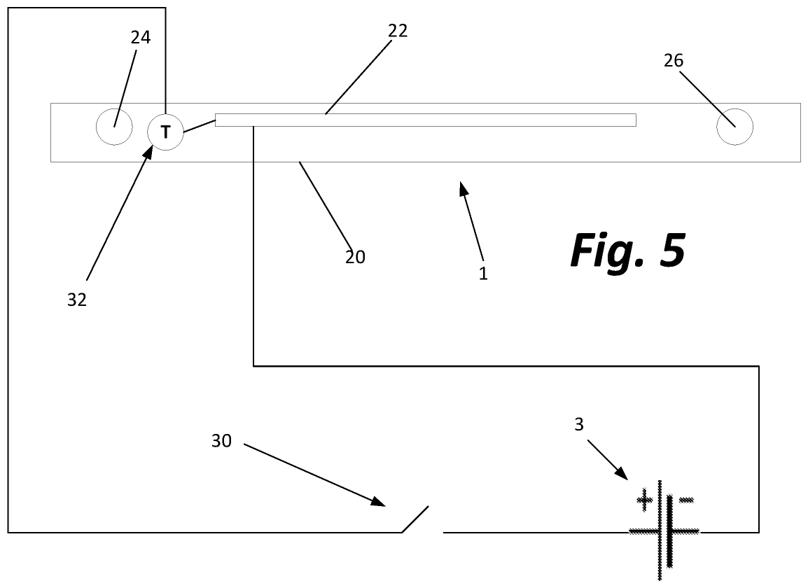

The alternative embodiment of FIGS. 2 and 4 replaces the metal bar 10 with a different heater, specifically with an assembly comprising a heat sink 20 and a heating element 22. Heat sink 20 may be made of any material having a high thermal conductivity. Copper may be used, for example. However, aluminum may be more suitable due to its lower cost and relatively high thermal conductivity. The heat sink 20 may be flat at shown, or otherwise have a flat surface, so that it can sit in face-to-face registration with the window 2. The heat sink may also have fins or pins to increase the surface area for heat transfer. Of course, the surface area of the heat sink should be large enough to permit adequate disbursement of heat across window 2 and small enough or otherwise shaped so that heat sink 20 does not unduly hinder visibility through window 2.

The heating element 22 attached to the heat sink 20 may be a coil heating element made from resistant wire, a ribbon made essentially by flattening such wire, or a heating strip cut from a broader piece of resistant material. Use of such a ribbon or strip offers the advantage of producing heat faster and with less energy because of the higher surface to volume ratio as compared to a wire coil, and the increased surface contact between heating element 22 and heat sink 20. Alternatively, the heating element 22 may be a polyimide heating element, such as one constructed of an etched foil element encapsulated between two layers of polyimide film. A fluorinated ethylene propylene (FEP) adhesive may be used to attach the polyimide heater to the heat sink 20.

The heater assembly comprising heat sink 20 and heating element 22 may also be coupled to a window 2 to be kept clear of fog and frost using magnets of the type described above. As shown in FIG. 4, magnets 24 and 26 are imbedded or press-fit into opposite ends of heat sink 20. The heater assembly is then placed in face-to-face registration with one side of window 2. Magnets 16 and 18 are positioned in face-to-face registration with the opposite side of window 2. When opposite poles of magnets 26 and 16 and of magnets 26 and 18 face each other as shown in FIG. 4, these magnets serve to hold the defroster 1 in place. When the power source 3 is connected to, and thereby energizes, heating element 22, heat generated by heating element 22 is transferred to heat sink 20 and then from heat sink 20 to window 2, causing the window to warm preventing the formation of frost or fog, and eliminating any frost or fog that accumulated prior to the heating element 22 being energized.

Additional features may be included in other embodiments of the invention. As indicated in FIG. 5, these additional features may include a power switch 30 and a thermostat 32 added to the embodiment of FIGS. 2 and 4. Switch 30 may be used to turn on and off the flow of current from the power source. Thermostat 32 includes a bimetallic strip converting a temperature change (of the heat sink) into mechanical displacement. Specifically, the bimetallic strip serves as a switch, closing the circuit when the heat sink 20 is at (or below) the lowest temperature of a predetermined operating temperature range and opening the circuit whenever the highest temperature of a predetermined operating temperature is reached. The thermostat may also include a mechanism allowing a user to set a desired temperature for the heat sink. The same switch and thermostat may also be used in conjunction with the embodiment of FIGS. 1 and 3.

Fasteners other than the magnets described above may be used to temporarily couple the heater to the window 2 in a manner that allows for easy repositioning. As shown in FIGS. 6, the heater comprising heat sink 20 and heat strip 22 is attached along an edge of the window 2 using a pair of spring clips or spring binders (collectively referred to as “spring binder clips”) 40 and 42. The heat sink 20 is placed in face-to-face registration with a surface of the window. One side of each of the spring binder clips 40 and 42 engages the heat sink 20 while the other side of the spring binder clips 40 and 42 engages the opposite surface of the window. A pinching force is applied by these sides of the spring binder clips 40 and 42 which serves to hold the heater in place. Application of sufficient force to overcome this pinching force releases the heater permitting the heater to be removed or repositioned.

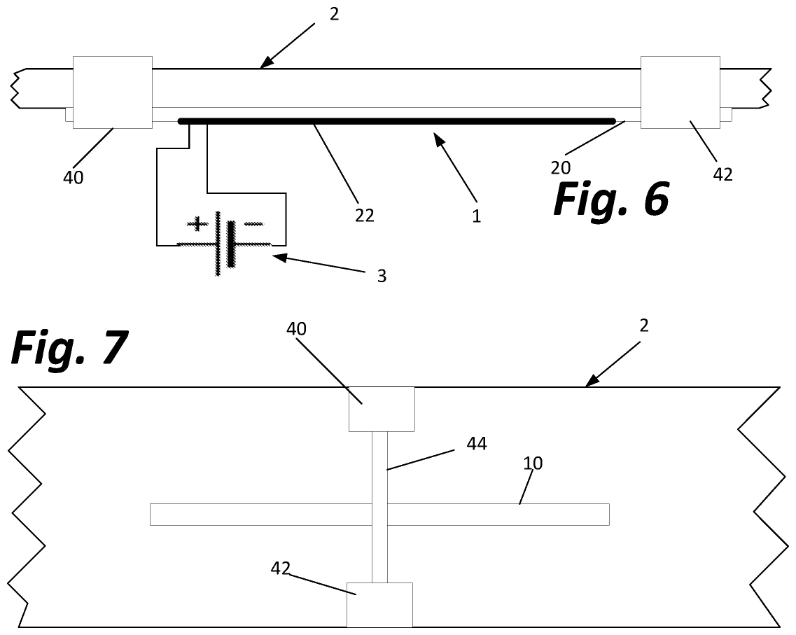

As shown in FIGS. 7, the heater comprising metal bar 10 is attached to the window 2 away from each edge of the window 2 using a pair of spring binder clips 40 and 42, in combination with a strap 44. Metal bar 10 is placed in face-to-face registration with a first surface of the window. Strap 44 is extended over the metal bar 10 and substantially across the length of window 2 from edge to edge such that the metal bar is sandwiched between the strap and the first surface of window 2. One side of each of the spring binder clips 40 and 42 engages an end of the strap while the other side of each of the spring binder clips 40 and 42 engages the opposite surface of the window. A pinching force is applied by the spring binder clips 40 and 42 to the opposite ends of strap 44 which serves to hold the strap and heater in place. Application of sufficient force to overcome this pinching force releases the strap and heater permitting the heater to be removed or repositioned.

One skilled in the art will appreciate that the heater can be attached to the surface of the window in other ways such as by using hook and loop type fasteners. Adhesives may also be used. For example, an adhesive strip may be applied to a surface of either the metal bar 10 or heat sink 20 and the adhesive strip may then be brought into contact with window 2 causing the heater to stick to the window. The adhesive may be used to permanently affix the heater to the window. However, such an adhesive fastener should permit the heater to be easily detached from the window and then reattached using the same adhesive strip after the heater is repositioned.

The ability to reposition the heater offers an important advantage related to power consumption, particularly when the power source is a battery. Power consumption may be reduced by defrosting only a selected portion of the window. Lithium-ion batteries offer the advantages of being rechargeable and portable. A twelve-volt, twelve amp-hour battery typically weighs under five pounds and can power a heater drawing four amps for at least three hours. This is often a sufficient length of time, but if a hunter, for example, plans on being in the blind for a longer time, a larger capacity battery or multiple batteries may be used to power the heater and thereby defog or defrost a portion of the window. Various additional advantages of the present invention should be apparent to one of ordinary skill in the art from the foregoing detailed description and the accompanying drawings. This disclosure is therefore not intended to be limiting.

1. A window defroster comprising:
a. a heater configured to operate within an operating temperature range of 80 degrees Fahrenheit to 110 degrees Fahrenheit, and be placed in face-to-face registration with a first side of a window,
b. a first fastener configured to temporarily couple the heater to the first side of the window at a first selected position, said first fastener further configured to permit decoupling of the heater from the first side of the window and temporarily recouple the heater to the first side of the window at least one second selected position,
c. a portable power source configured to deliver power to the heater.

2. The window defroster of claim 1 wherein said heater comprises a metal bar made from a material that is resistive, has a melting point above the highest temperature of the predetermined operating temperature range, and has a temperature coefficient of resistivity sufficiently low to enable the heater to generate sufficient heat to defrost and defog the window.

3. The window defroster of claim 2 wherein said material is selected from a group consisting of aluminum, black anodized aluminum, Nickel-Chromium alloys, Iron-Chrome-Aluminum alloys, Copper-Nickel alloys.

4. The window defroster of claim 2 wherein the highest temperature of the operating temperature range is set based on the shape and material of the metal bar and the amount of current supplied to the metal bar.

5. The window defroster of claim 2 wherein the highest temperature of the operating range is set by a thermostat.

6. The window defroster of claim 1 wherein said heater comprises a heating element and a heat sink.

7. The window defroster of claim 6 wherein said heating element is polyimide heater constructed of an etched foil encapsulated between two layers of polyimide film.

8. The window defroster of claim 6 wherein said heating element is made from a material that is resistive, has a melting point above the highest temperature of the predetermined operating temperature range, and has a temperature coefficient of resistivity sufficiently low to enable the heater to generate sufficient heat to defrost and defog the window.

9. The window defroster of claim 8 wherein said material is selected from a group consisting of aluminum, black anodized aluminum, Nickel-Chromium alloys, Iron-Chrome-Aluminum alloys, Copper-Nickel alloys.

10. The window defroster of claim 6 wherein the heat sink is made of any material having sufficiently high thermal conductivity to transfer most of the heat generated by the heating element to the window.

11. The window defroster of claim 10 wherein the heat sink is made from a group of materials consisting of copper and aluminum.

12. The window defroster of claim 6 wherein the heat sink has a flat surface so that that the heat sink is configured to sit in face-to-face registration with the window.

13. The window defroster of claim 6 wherein the heat sink has structures configured to increase the surface area for heat transfer to selected portions of the window.

14. The window defroster of claim 6 wherein the heat sink has a surface area selected to be large enough to permit adequate disbursement of heat across window and shaped so that the heat sink permits visibility through at least a portion of the window.

15. The window defroster of claim 6 wherein power from the portable power supply to the heating element is controlled by a thermostat.

16. The window defroster of claim 1 wherein the first fastener comprises a first magnet configured to be attached to the heater and a second magnet configured to be placed in face-to-face registration with a second side of the window and cooperate with the first magnet to couple the heater to the window, wherein each of said first magnet and said second magnet is resistant to demagnetization at all temperatures within the operating temperature range.

17. The window defroster of claim 1 wherein the first fastener comprises a spring binder clip.

18. A window defroster comprising:
a. a heater configured to be powered by a portable power source, operate within a predetermined operating temperature range when powered by the portable power source, and be placed in face-to-face registration with a first side of a window, said heater comprising a metal bar made from an alloy that is resistive, has a melting point above the highest temperature of the predetermined operating temperature range, and has a temperature coefficient of resistivity sufficiently low to enable the heater to generate sufficient heat to defrost and defog the window;
b. a first set of magnets, each magnet of said first set of magnets configured to be attached to the heater and being resistant to demagnetization at all temperatures within the predetermined operating temperature range of, and
c. a second set of magnets, configured to be placed in face-to-face registration with a second side of the window and cooperate with the first set of magnets to couple the heater to the window, each magnet of said second set of magnets resistant to demagnetization at all temperatures within the predetermined operating temperature range.

19. A window defroster comprising:
a. a heater configured to be powered by a portable power source, operate with in a predetermined operating temperature range when powered by the portable power source, and be placed in face-to-face registration with a first side of a window, said heater comprising a polyimide heating element;
b. a first set of magnets, each magnet of said first set of magnets configured to be attached to the heater and being resistant to demagnetization at all temperatures within the predetermined operating temperature range of the heater, and
c. a second set of magnets configured to be placed in face-to-face registration with a second side of the window and cooperate with the first set of magnets to couple the heater to the window, each magnet of said second set of magnets resistant to demagnetization at all temperatures within the predetermined operating temperature range.

20. The window defroster of claim 19 wherein the polyimide heating element comprises an etched film encapsulated between two layers of polyimide film and the magnets each are covered with an epoxy coating.
